(19) United States
(12) Patent Application Publication
(10) Pub. No.: US 2022/0407067 A1
(43) Pub. Date: Dec. 22, 2022

(54) METHOD FOR MANUFACTURING POSITIVE ELECTRODE, POSITIVE ELECTRODE, AND LITHIUM ION SECONDARY BATTERY

(71) Applicant: HONDA MOTOR CO., LTD., Tokyo (JP)

(72) Inventors: Kazuhiro ARAKI, Saitama (JP); Akihiro YANASE, Saitama (JP); Tadahiro FUKUSHIMA, Saitama (JP); Hiromitsu SATO, Saitama (JP); Shin IRINO, Saitama (JP)

(21) Appl. No.: 17/664,657

(22) Filed: May 24, 2022

(30) Foreign Application Priority Data
Jun. 16, 2021 (JP) 2021-100218

(51) Int. Cl. H01M 4/583; H01M 10/0525; H01M 4/62; H01M 4/04

(52) U.S. Cl. CPC H01M 4/583; H01M 10/0525; H01M 4/623; H01M 4/0404; H01M 2004/028

(57) ABSTRACT

Provided is a positive electrode manufacturing method including the step of mixing carbon particles, a first binder, a first dispersant, and a first solvent to form a first dispersion, the step of mixing carbon nanotubes, a second binder, a second dispersant, and a second solvent to form a second dispersion, the step of mixing one of the first dispersion or the second dispersion with a positive electrode active material to form a third dispersion, the step of mixing the other one of the first dispersion or the second dispersion with the third dispersion to form a fourth dispersion, and the step of applying the fourth dispersion to a positive electrode current collector to form a positive electrode material mixture layer.

This application is based on and claims the benefit of priority from Japanese Patent Application No. 2021-100218, filed on 16 Jun. 2021, the content of which is incorporated herein by reference.

### BACKGROUND OF THE INVENTION

### Field of the Invention

The present invention relates to a method for manufacturing a positive electrode, a positive electrode, and a lithium ion secondary battery.

### Related Art

Typically, a lithium ion secondary battery has been in widespread use as a power storage device having a high energy density. The lithium ion secondary battery is configured such that a separator impregnated with an electrolytic solution or a solid electrolyte layer is arranged between a positive electrode and a negative electrode.

The positive electrode is, for example, manufactured in such a manner that a dispersion including a positive electrode active material, a conductive aid, a binder, a dispersant, and a solvent is applied to a positive electrode current collector to form a positive electrode material mixture layer, and carbon nanotubes have been known as the conductive aid (see, e.g., Japanese Unexamined Patent Application, Publication No. 2018-120845).
Patent Document 1: Japanese Unexamined Patent Application, Publication No. 2018-120845

### SUMMARY OF THE INVENTION

The carbon nanotubes as described herein easily aggregate, and for this reason, the aggregated carbon nanotubes are disaggregated by application of shear force when forming the dispersion. However, the carbon nanotubes reaggregate in the dispersion, and for this reason, there are problems that contact among the carbon nanotubes and the positive electrode active material in the positive electrode decreases and the DC resistance of the lithium ion secondary battery increases.

An object of the present invention is to provide a positive electrode manufacturing method capable of decreasing the DC resistance of a lithium ion secondary battery.

One aspect of the present invention is a positive electrode manufacturing method including the step of mixing carbon particles, a first binder, a first dispersant, and a first solvent to form a first dispersion, the step of mixing carbon nanotubes, a second binder, a second dispersant, and a second solvent to form a second dispersion, the step of mixing one of the first dispersion or the second dispersion with a positive electrode active material to form a third dispersion, the step of mixing the other one of the first dispersion or the second dispersion with the third dispersion to form a fourth dispersion, and the step of applying the fourth dispersion to a positive electrode current collector to form a positive electrode material mixture layer.

In the above-described positive electrode manufacturing method, the first dispersion and the positive electrode active material may be mixed to form the third dispersion, and the second dispersion and the third dispersion may be mixed to form the fourth dispersion.

Another aspect of the present invention is a positive electrode manufactured by the above-described positive electrode manufacturing method.

Still another aspect of the present invention is a lithium ion secondary battery including the above-described positive electrode.

According to the present invention, the positive electrode manufacturing method capable of decreasing the DC resistance of the lithium ion secondary battery can be provided.

### BRIEF DESCRIPTION OF THE DRAWINGS

FIGS. 1A and 1B show SEM images of a surface of a positive electrode material mixture layer in a positive electrode of Example 1;

FIG. 2 shows a SEM image of a surface of a positive electrode material mixture layer in a positive electrode of Example 3; and

FIGS. 3A and 3B show SEM images of a surface of a positive electrode material mixture layer in a positive electrode of Comparative Example 1.

### DETAILED DESCRIPTION OF THE INVENTION

Hereinafter, an embodiment of the present invention will be described.

### [Positive Electrode Manufacturing Method]

The method for manufacturing a positive electrode according to the present embodiment includes the step of mixing carbon particles, a first binder, a first dispersant, and a first solvent to form a first dispersion and the step of mixing carbon nanotubes, a second binder, a second dispersant, and a second solvent to form a second dispersion. Further, the method for manufacturing the positive electrode according to the present embodiment includes the step of mixing one of the first dispersion or the second dispersion with a positive electrode active material to form a third dispersion, the step of mixing the other one of the first dispersion or the second dispersion with the third dispersion to form a fourth dispersion, and the step of applying the fourth dispersion to a positive electrode current collector to form a positive electrode material mixture layer. By this method, shear force applied to the carbon nanotubes is reduced, and therefore, reaggregation of the carbon nanotubes in the fourth dispersion is reduced. As a result, contact among the carbon nanotubes and the positive electrode active material in the positive electrode increases, and therefore, the DC resistance of a lithium ion secondary battery is decreased.

The form of the dispersion described herein is not particularly limited, and examples thereof include a paste, a slurry, and the like.

When forming the third dispersion and the fourth dispersion, viscosity may be adjusted by addition of a solvent as necessary. The solvent may be the same as the first solvent or the second solvent, or may be different from the first solvent or the second solvent.

The positive electrode current collector on which the positive electrode material mixture layer is formed may be rolled as necessary.

In the method for manufacturing the positive electrode according to the present embodiment, the first dispersion and the positive electrode active material are preferably mixed with each other to form the third dispersion, and the second dispersion and the third dispersion are preferably mixed with each other to form the fourth dispersion. By this method, the shear force applied to the carbon nanotubes is further reduced, and therefore, reaggregation of the carbon nanotubes in the fourth dispersion is further reduced.

The other one of the first dispersion or the second dispersion is preferably mixed with the third dispersion at a shear rate of equal to or less than 5.2 s⁻¹. By this method, the shear force applied to the carbon nanotubes is further reduced, and therefore, reaggregation of the carbon nanotubes in the fourth dispersion is further reduced.

The carbon particles are not particularly limited as long as they are conductive, and examples of the carbon particles include particles of carbon black such as furnace black, channel black, acetylene black, and thermal black, particles of black lead such as artificial black lead and natural black lead, and the like. Two or more types of these materials may be used in combination.

Marketed products of carbon black may include DENKA BLACK (registered trademark) (manufactured by Denka Company Limited) and KETJENBLACK (registered trademark) (manufactured by Lion Specialty Chemicals Co., Ltd.).

The average particle size of the carbon particles is not particularly limited, but is, for example, equal to or greater than 5 nm and equal to or less than 100 nm.

The fiber diameter of the carbon nanotubes is not particularly limited, but is, for example, equal to or greater than 5 nm and equal to or less than 10 nm.

The fiber length of the carbon nanotubes is not particularly limited, but is, for example, equal to or greater than 5 μm and equal to or less than 20 μm.

The first binder and the second binder are not particularly limited, and examples thereof include polyvinylidene fluoride (PVDF), styrene-butadiene rubber (SBR), carboxymethylcellulose (CMC), and the like. Two or more types of these materials may be used in combination.

The first binder and the second binder as described herein may be the same as each other, or may be different from each other.

The first dispersant and the second dispersant are not particularly limited, and examples thereof include polymer dispersants such as polyvinyl alcohol, polyvinyl pyrrolidone, and polyacrylonitrile, anionic surfactants, nonionic surfactants, and the like. Two or more types of these materials may be used in combination.

The first dispersant and the second dispersant as described herein may be the same as each other, or may be different from each other.

The first solvent and the second solvent are not particularly limited, and examples thereof include N-methyl-2-pyrrolidone (NMP), N,N-dimethylformamide (DMF), dimethylacetamide (DMA), N-methylformamide (NMF), and the like. Two or more types of these materials may be used in combination.

The first solvent and the second solvent as described herein may be the same as each other, or may be different from each other.

The positive electrode active material is not particularly limited, and examples thereof include LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂O₄, LiNiO₂, LiFePO₄, lithium sulfide, sulfur, and the like. Two or more types of these materials may be used in combination.

The positive electrode current collector is not particularly limited, and examples thereof include aluminum foil and the like.

The content of the positive electrode active material in the positive electrode material mixture layer is not particularly limited, but is, for example, equal to or greater than 80% by mass and equal to or less than 99% by mass.

The content of the carbon particles in the positive electrode material mixture layer is not particularly limited, but is, for example, equal to or greater than 0.5% by mass and equal to or less than 10% by mass.

The content of the carbon nanotubes in the positive electrode material mixture layer is not particularly limited, but is, for example, equal to or greater than 0.5% by mass and equal to or less than 3% by mass.

The total content of the first binder and the second binder in the positive electrode material mixture layer is not particularly limited, but is, for example, equal to or greater than 0.5% by mass and equal to or less than 5% by mass.

### [Positive Electrode]

The positive electrode of the present embodiment is manufactured by the positive electrode manufacturing method of the present embodiment.

The positive electrode of the present embodiment is preferably formed such that at least part of a surface of the positive electrode active material is covered with the carbon particles and the carbon nanotubes, but the carbon particles and the carbon nanotubes are not aggregated. With this configuration, the DC resistance of the lithium ion secondary battery is further decreased.

### [Lithium Ion Secondary Battery]

The lithium ion secondary battery of the present embodiment is configured such that a separator impregnated with an electrolytic solution or a solid electrolyte layer is arranged between the positive electrode of the present embodiment and a negative electrode.

The negative electrode is not particularly limited, and has, for example, a negative electrode current collector and a negative electrode material mixture layer.

The negative electrode current collector is not particularly limited, and examples thereof include copper foil and the like.

The negative electrode material mixture layer is not particularly limited, and includes, for example, a negative electrode active material, a conductive aid, and a binder.

The negative electrode active material is not particularly limited, and examples thereof include black lead such as natural black lead and artificial black lead, hard carbon, activated carbon, Si, SiOx, Sn, SnOx, and the like.

The conductive aid is not particularly limited, and examples thereof include acetylene black, carbon nanotubes, and the like.

The binder is not particularly limited, and examples thereof include polyvinylidene fluoride (PVDF), styrene-butadiene rubber (SBR), carboxymethylcellulose (CMC), and the like.

The electrolytic solution is not particularly limited, and includes, for example, an electrolyte, a solvent, and an additive.

The electrolyte is not particularly limited, and examples thereof include lithium salts such as LiPF₆, lithium bis(trifluoromethane) sulfoneimide (LiTFSI), lithium bis(oxalate)borate (LiBOB), lithium difluorophosphate (LiDPF), lithium difluoro(oxalato)borate (LiDFOB), and the like.

The solvent is not particularly limited, and examples thereof include ethylene carbonate (EC), propylene carbonate (PC), dimethyl carbonate (DMC), ethylmethyl carbonate (EMC), diethyl carbonate (DEC), γ-butyrolactone (GBL), and the like.

The additive is not particularly limited, and examples thereof include vinylene carbonate (VC), fluoroethylene carbonate (FEC), propane sultone (PS), propene sultone (PRS), and the like.

The separator is not particularly limited, and for example, a porous resin film or the like may be used.

A material forming the porous resin film is not particularly limited, and examples thereof include polyethylene (PE), polypropylene (PP), aramid resin, and the like.

Note that the porous resin film may be formed such that a surface thereof is coated with a ceramic.

A material forming the ceramic coating is not particularly limited, and examples thereof include SiOx, Al₂O₃, and the like.

A solid electrolyte forming the solid electrolyte layer is not particularly limited, and examples thereof include an oxide-based electrolyte, a sulfide-based electrolyte, and the like.

### EXAMPLES

Hereinafter, examples of the present invention will be described, but the present invention is not limited to these examples.

### Example 1

DENKA BLACK (registered trademark) (manufactured by Denka Company Limited) as acetylene black, KF Polymer #1100 (registered trademark) (manufactured by Kureha Corporation) as PVDF, a dispersant, and NMP were mixed to form a first dispersion (slurry).

Carbon nanotubes with a fiber length of 5 to 20 μm, a fiber diameter of 5 to 10 nm, and a fineness of 99% or greater, KF Polymer #1100 (registered trademark) (manufactured by Kureha Corporation) as PVDF, a dispersant, and NMP were mixed to form a second dispersion (slurry).

The first dispersion and LiNi_{0.3}Co_{0.33}Mn_{0.33}O₂ having an average particle size of 4 μm as a positive electrode active material were stirred and mixed at a rotation speed of 20 to 25 rpm (a shear rate of 2.1 to 2.6 s⁻¹) by a planetary mixer, thereby forming a third dispersion (slurry).

The second dispersion and the third dispersion were stirred and mixed at a rotation speed of 20 to 25 rpm (a shear rate of 2.1 to 2.6 s⁻¹) by the planetary mixer, and thereafter, the viscosity of the resultant was adjusted by addition of an NMP solvent. In this manner, a fourth dispersion (slurry) was formed.

The fourth dispersion was applied to Al foil having a thickness of 12 μm as a positive electrode current collector, and the resultant was dried such that a positive electrode material mixture layer was formed. Thereafter, the resultant was rolled, and in this manner, a positive electrode was formed. The composition [% by mass] of a positive electrode material mixture forming the positive electrode material mixture layer is as follows:

Positive Electrode Active Material:Acetylene Black:Carbon Nanotubes:PVDF=95:1.5:1.5:2

Part of the positive electrode was cut out, and thereafter, a surface of the positive electrode material mixture layer was observed using a scanning electron microscope (SEM).

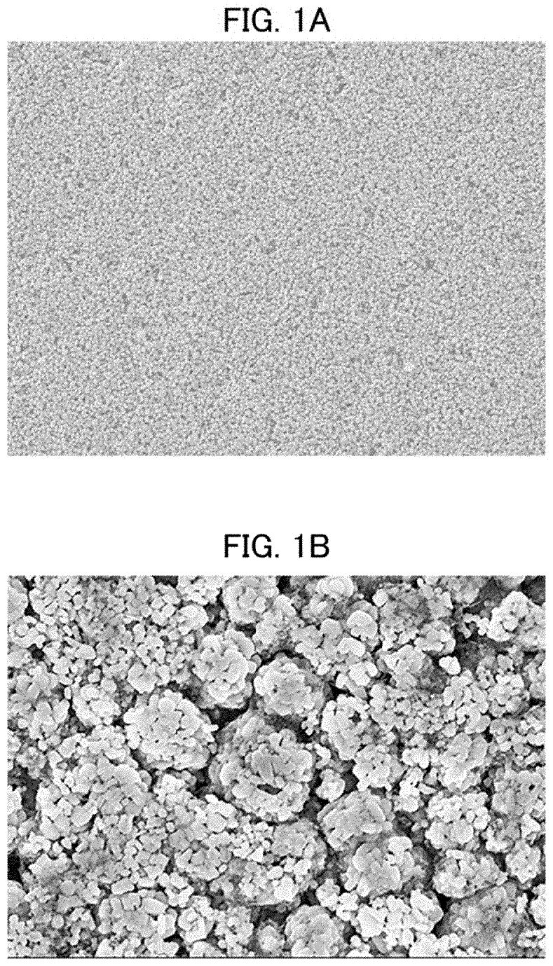

FIGS. 1A and 1B show SEM images of the surface of the positive electrode material mixture layer. FIGS. 1A and 1B show the SEM images with a magnification of 1000× and 5000×.

FIGS. 1A and 1B show that acetylene black and the carbon nanotubes are not aggregated.

### Example 2

A positive electrode was formed in a manner similar to that of Example 1, except that for formation of a third dispersion and a fourth dispersion, materials were stirred and mixed at a rotation speed of 20 to 25 rpm (a shear rate of 2.1 to 2.6 s⁻¹) and a rotation speed of 500 rpm (a shear rate of 52.3 s⁻¹) by a planetary mixer and a disperser.

As a result of observation of a surface of a positive electrode material mixture layer as in Example 1, it was confirmed that acetylene black and carbon nanotubes are not aggregated.

### Example 3

A positive electrode was formed in a manner similar to that of Example 1, except that a second dispersion was used instead of a first dispersion for formation of a third dispersion and the first dispersion was used instead of the second dispersion for formation of a fourth dispersion.

As in Example 1, a surface of a positive electrode material mixture layer was observed.

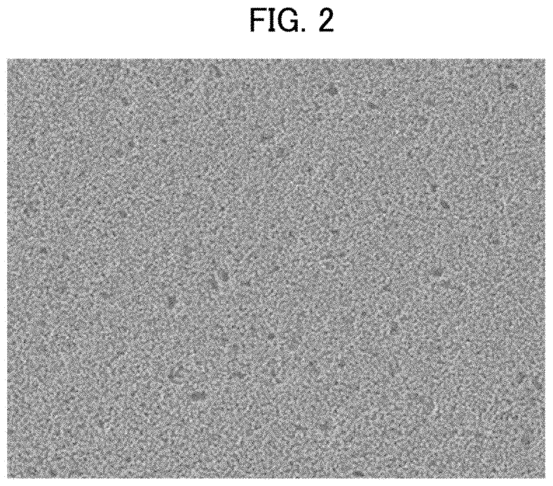

FIG. 2 shows a SEM image of the surface of the positive electrode material mixture layer. FIG. 2 shows the SEM image with a magnification of 1000×.

FIG. 2 shows that acetylene black and carbon nanotubes are slightly aggregated.

### Example 4

A positive electrode was formed in a manner similar to that of Example 2, except that a second dispersion was used instead of a first dispersion for formation of a third dispersion and the first dispersion was used instead of the second dispersion for formation of a fourth dispersion.

As a result of observation of a surface of a positive electrode material mixture layer as in Example 1, it was confirmed that acetylene black and carbon nanotubes are slightly aggregated.

### Comparative Example 1

DENKA BLACK (registered trademark) (manufactured by Denka Company Limited) as acetylene black, carbon nanotubes with a fiber length of 5 to 20 μm, a fiber diameter of 5 to 10 nm, and a fineness of 991 or greater, KF Polymer #1100 (registered trademark) (manufactured by Kureha Corporation) as PVDF, a dispersant, and NMP were mixed to form a first dispersion (slurry).

The first dispersion and LiNi_{0.33}Co_{0.33}Mn_{0.33}O₂ having an average particle size of 4 μm as a positive electrode active material were stirred and mixed at 20 to 25 rpm by a planetary mixer, and thereafter, the viscosity of the resultant was adjusted by addition of an NMP solvent. In this manner, a second dispersion (slurry) was formed.

The second dispersion was applied to Al foil having a thickness of 12 μm as a positive electrode current collector, and the resultant was dried such that a positive electrode material mixture layer was formed. Thereafter, the resultant was rolled, and in this manner, a positive electrode was formed. The composition [% by mass] of a positive electrode material mixture forming the positive electrode material mixture layer is as follows:

Positive Electrode Active Material:Acetylene Black:Carbon Nanotubes:PVDF=95:1.5:1.5:2

As in Example 1, a surface of the positive electrode material mixture layer was observed.

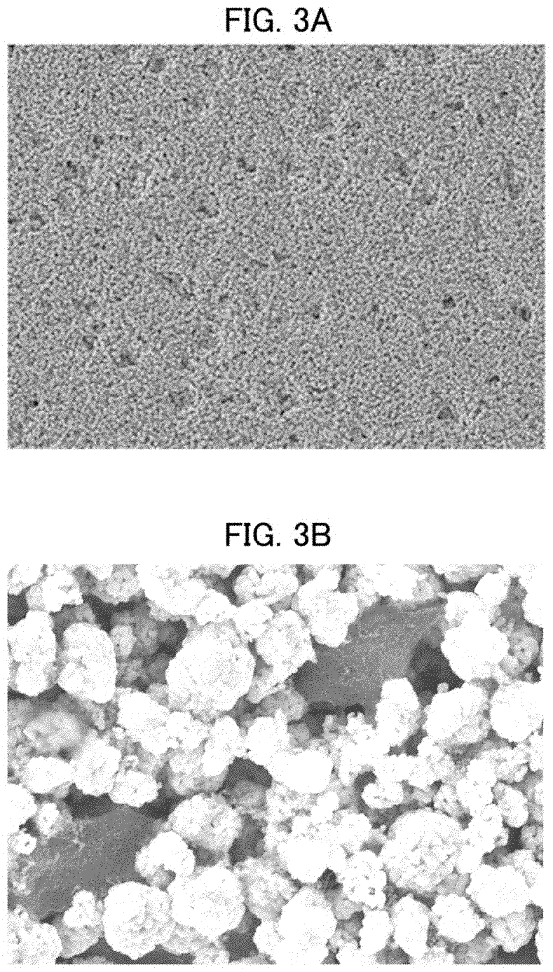

FIGS. 3A and 3B show SEM images of the surface of the positive electrode material mixture layer. FIGS. 3A and 3B show the SEM images with a magnification of 1000× and 5000×.

FIGS. 3A and 3B show that acetylene black and the carbon nanotubes are aggregated.

### Comparative Example 2

A positive electrode was formed in a manner similar to that of Comparative Example 1, except that for formation of a second dispersion, materials were stirred and mixed at 20 to 25 rpm and 500 rpm by a planetary mixer and a disperser.

As a result of observation of a surface of a positive electrode material mixture layer as in Example 1, it was confirmed that acetylene black and carbon nanotubes are aggregated.

Next, the DC resistance (DCR) of a lithium ion secondary battery was evaluated using the positive electrodes of the examples and the comparative examples.

### [DCR of Lithium Ion Secondary Battery]

Graphite as a negative electrode active material, DENKA BLACK (registered trademark) (manufactured by Denka Company Limited) as acetylene black, styrene-butadiene rubber (SBR), carboxymethylcellulose (CMC), and water were mixed to form a dispersion (slurry).

The dispersion was applied to Cu foil having a thickness of 4 μm as a negative electrode current collector, and the resultant was dried such that a negative electrode material mixture layer was formed. Thereafter, the resultant was rolled, and in this manner, a negative electrode was formed.

The positive electrode and the negative electrode were stacked on each other with a separator being interposed therebetween, and the separator was impregnated with an electrolytic solution. Thereafter, the resultant was sealed with a laminated film, and a lithium ion secondary battery with a discharge capacity of 1 Ah was formed.

The lithium ion secondary battery was adjusted to an open circuit voltage (OCV) corresponding to a state-of-charge (SOC) of 50% in a state in which the temperature of the lithium ion secondary battery is held at 60° C., and thereafter, discharged with 30 A corresponding to 30 C for 10 seconds. Then, the DCR was calculated according to Expression [V(0 s)−V(10 s)]/I.

Table 1 shows the results of evaluation of the DCR of the lithium ion secondary battery. The value of the DCR as described herein is a value relative to the value of the DCR of Example 1.

TABLE 1

| | DCR [—] |
|---|---|
| Example 1 | 1.00 |
| Example 2 | 1.04 |
| Example 3 | 1.07 |
| Example 4 | 1.09 |
| Comparative Example 1 | 1.12 |
| Comparative Example 2 | 1.14 |

Table 1 shows that the positive electrodes of Examples 1 to 4 have smaller lithium ion secondary battery DCRs than those of the positive electrodes of Comparative Examples 1 and 2.

What is claimed is:

1. A method for manufacturing a positive electrode, comprising:
a step of mixing carbon particles, a first binder, a first dispersant, and a first solvent to form a first dispersion;
a step of mixing carbon nanotubes, a second binder, a second dispersant, and a second solvent to form a second dispersion;
a step of mixing one of the first dispersion or the second dispersion with a positive electrode active material to form a third dispersion;
a step of mixing the other one of the first dispersion or the second dispersion with the third dispersion to form a fourth dispersion; and
a step of applying the fourth dispersion to a positive electrode current collector to form a positive electrode material mixture layer.

2. The method for manufacturing the positive electrode according to claim 1, wherein
the first dispersion and the positive electrode active material are mixed to form the third dispersion, and
the second dispersion and the third dispersion are mixed to form the fourth dispersion.

3. A positive electrode manufactured by the method for manufacturing the positive electrode according to claim 1.

4. A lithium ion secondary battery comprising: the positive electrode according to claim 3.
